(19) United States
(12) Patent Application Publication
(10) Pub. No.: US 2014/0168394 A1
(43) Pub. Date: Jun. 19, 2014

(54) IMAGE PROCESSING DEVICE, STEREOSCOPIC IMAGE DISPLAY, AND IMAGE PROCESSING METHOD

(71) Applicant: KABUSHIKI KAISHA TOSHIBA, Tokyo (JP)

(72) Inventors: Kenichi Shimoyama, Tokyo (JP); Ryusuke Hirai, Tokyo (JP); Takeshi Mita, Yokohama-shi (JP); Nao Mishima, Tokyo (JP); Norihiro Nakamura, Kawasaki-shi (JP); Yoshiyuki Kokojima, Yokohama-shi (JP)

(73) Assignee: KABUSHIKI KAISHA TOSHIBA, Tokyo (JP)

(21) Appl. No.: 14/187,843

(22) Filed: Feb. 24, 2014

Related U.S. Application Data
(63) Continuation of application No. PCT/JP2011/069328, filed on Aug. 26, 2011.

(51) Int. Cl. H04N 13/04

(52) U.S. Cl. CPC H04N 13/0404; H04N 13/0415; H04N 13/0477
USPC 348/59

(57) ABSTRACT

According to an embodiment, an image processing device includes an acquirer, a calculator, and a display controller. The acquirer is configured to acquire a three-dimensional coordinate value that indicates a position of a viewer. The calculator is configured to, using the three-dimensional coordinate value, calculate a reference coordinate value that indicates a position of the viewer in a reference plane that includes a visible area within which the viewer is able to view a stereoscopic image. The display controller is configured to control a display, which displays the stereoscopic image for which the visible area is different for each different height, so as to display information corresponding to the reference coordinate value.

### CROSS-REFERENCE TO RELATED APPLICATIONS

This application is a continuation of PCT international application Ser. No. PCT/JP2011/069328 filed on Aug. 26, 2011 which designates the United States; the entire contents of which are incorporated herein by reference.

### FIELD

Embodiments described herein relate generally to an image processing device, a stereoscopic image display, and an image processing method.

### BACKGROUND

There are stereoscopic image displays which enable viewers to view stereoscopic images with the unaided eye and without having to put on special glasses. In such a stereoscopic image display, a plurality of images having mutually different viewpoints is displayed, and the light beams coming out from the images are controlled using, for example, a parallax barrier or a lenticular lens. The controlled light beams are then guided to both eyes of the viewer. If the viewer is present at an appropriate viewing position, then he or she becomes able to recognize stereoscopic images. Herein, the area within which the viewer is able to view stereoscopic images is called a visible area.

However, there is an issue that the visible area is limited in nature. For example, there exists a reverse visible area which includes viewing positions at which the viewpoint for the images perceived by the left eye is placed relatively on the right side of the viewpoint for the images perceived by the right eye, and thus the stereoscopic images are not correctly recognizable.

Conventionally, as far as a technology for setting the visible area according to the position of a viewer is concerned, a technology is known in which the position of a viewer is detected using a sensor, and the position of the visible area is controlled by interchanging the images for left eye and the images for right eye according to the position of the viewer.

However, in the conventional technology, the position of the viewer in the height direction is not at all taken into account. For that reason, in a stereoscopic image display that displays stereoscopic images having a different visible area for each different height; if a viewer is present at a different height than the height of the supposed viewing position, then it becomes difficult for the viewer to view the stereoscopic images.

### BRIEF DESCRIPTION OF THE DRAWINGS

FIG. 1 is a diagram illustrating an example of a stereoscopic image display according to a first embodiment;

FIG. 2 is a diagram illustrating an example of a display according to the first embodiment;

FIG. 3 is a diagram illustrating an example of placing an aperture controller according to the first embodiment;

FIG. 4 is a diagram illustrating an example of visible areas according to the first embodiment;

FIG. 5 is a diagram illustrating an example of visible areas according to the first embodiment;

FIG. 6 is a diagram illustrating an example of visible areas according to the first embodiment;

FIG. 7 is a diagram illustrating an example of visible areas according to the first embodiment;

FIG. 8 is a diagram illustrating an example of an image processing device according to the first embodiment;

FIG. 9 is a diagram illustrating an example of a notification picture;

FIG. 10 is a diagram illustrating an example of a notification picture;

FIG. 11 is a flowchart for explaining an example of the operations performed in the image processing device according to the first embodiment;

FIG. 12 is a diagram for explaining the control performed with respect to a visible area;

FIG. 13 is a diagram for explaining the control performed with respect to a visible area;

FIG. 14 is a diagram for explaining the control performed with respect to a visible area;

FIG. 15 is a diagram illustrating an example of an image processing device according to a second embodiment;

FIG. 16 is a flowchart for explaining an example of the operations performed in the image processing device according to the second embodiment; and

FIG. 17 is a diagram illustrating a modification example of a display controller.

### DETAILED DESCRIPTION

According to an embodiment, an image processing device includes an acquirer, a calculator, and a display controller. The acquirer is configured to acquire a three-dimensional coordinate value that indicates a position of a viewer. The calculator is configured to, using the three-dimensional coordinate value, calculate a reference coordinate value that indicates a position of the viewer in a reference plane that includes a visible area within which the viewer can view a stereoscopic image. The display controller is configured to control a display, which display the stereoscopic image for which the visible area is different for each different height, so as to display information corresponding to the reference coordinate value.

Various embodiments will be described below in details with reference to the accompanying drawings.

### First Embodiment

An image processing device 10 according to a first embodiment is used in a stereoscopic image display such as a TV, a PC, a smartphone, or a digital photo frame that enables a viewer to view stereoscopic images with the unaided eye. Herein, a stereoscopic image is an image that includes a plurality of parallax images having mutually different parallaxes. Meanwhile, the images mentioned in the embodiments can either be still images or be moving images.

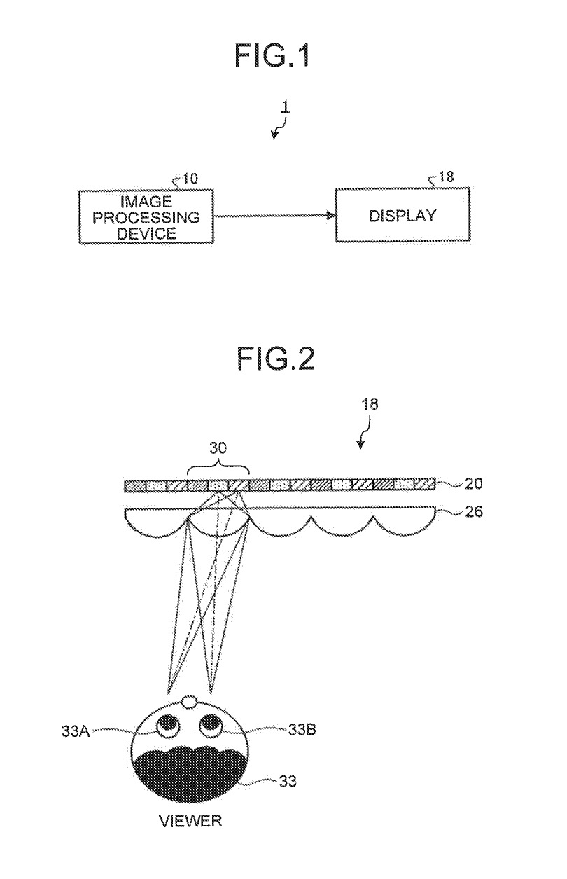

FIG. 1 is a block diagram illustrating a configuration example of a stereoscopic image display 1 according to the first embodiment. The stereoscopic image display 1 includes the image processing device 10 and a display 18. The image processing device 10 is a device that performs image processing. The details of the image processing device 10 are given later.

The display 18 is a device that displays stereoscopic images having a different visible area for each different height. Herein, the visible area points to a range (area) within which a viewer is able to view the stereoscopic images displayed by the display 18. This viewable range is a range (area) in the real space. The visible area is determined according to a combination of display parameters (details given later) of the display 18. Thus, by setting the display parameters of the display 18, it becomes possible to set the visible area.

In the following explanation according to the first embodiment, in the real space, with the center of the display surface (display) of the display 18 treated as the origin, the horizontal direction of the display surface is set to be the X-axis; the vertical direction of the display surface is set to be the Y-axis; and the normal direction of the display surface is set to be the Z-axis. In the first embodiment, the height direction points to the Y-axis direction. However, the method of setting a coordinate in the real space is not limited to this particular method.

As illustrated in FIG. 2, the display 18 includes a display element 20 and an aperture controller 26. When a viewer views the display element 20 via the aperture controller 26, he or she becomes able to view the stereoscopic images displayed on the display 18.

The display element 20 displays parallax images that are used in displaying a stereoscopic image. As far as the display element 20 is concerned, it is possible to use a direct-view-type two-dimensional display such as an organic EL (organic Electro Luminescence), an LCD (Liquid Crystal Display), a PDP (Plasma Display Panel), or a projection-type display.

The display element 20 can have a known configuration in which, for example, sub-pixels of RGB colors are arranged in a matrix-like manner to form RGB pixels. In this case, a single pixel is made of RGB sub-pixels arranged in a first direction. Moreover, an image that is displayed on a group of pixels, which are adjacent pixels equal in number to the number of parallaxes and which are arranged in a second direction that intersects with the first direction, is called a element image 30. Herein, the first direction is, for example, the column direction (the vertical direction) and the second direction is, for example, the row direction (the horizontal direction). Meanwhile, any other known arrangement of sub-pixels can also be adopted in the display element 20. Moreover, the sub-pixels are not limited to the three colors of RGB. Alternatively, for example, the sub-pixels can also have four colors.

The aperture controller 26 emits the light beams, which are anteriorly emitted from the display element 20, toward a predetermined direction via apertures (hereinafter, apertures having such a function are called optical apertures). Examples of the aperture controller 26 include a lenticular lens and a parallax barrier.

The optical apertures are arranged corresponding to the element images 30 of the display element 20. When a plurality of element images 30 is displayed on the display element 20, a parallax image group corresponding to a plurality of parallax directions gets displayed (i.e., a multiple parallax image nets displayed) on the display element 20. The light beams coming out from this multiple parallax image pass through the optical apertures. Then, a viewer 33 present within the visible area view different pixels of the element images 30 with a left eye 33A and views different pixels of the element images 30 with a right eye 33B. In this way, when images having different parallaxes are displayed with respect to the left eye 33A and the right eye 33B of the viewer 33, it becomes possible for the viewer 33 to view stereoscopic images.

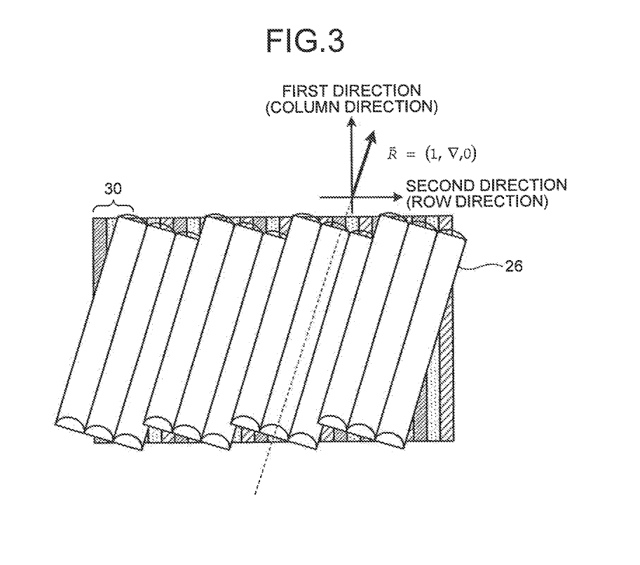

In the first embodiment, as illustrated in FIG. 3, the aperture controller 26 is disposed in such a way that the extending direction of the optical apertures thereof has a predetermined tilt with respect to the first direction of the display element 20. In the example illustrated in FIG. 3, a vector R indicating the line direction of the optical apertures can be expressed using Equation (1) given below.

R̅=(1,∇,0) (1)

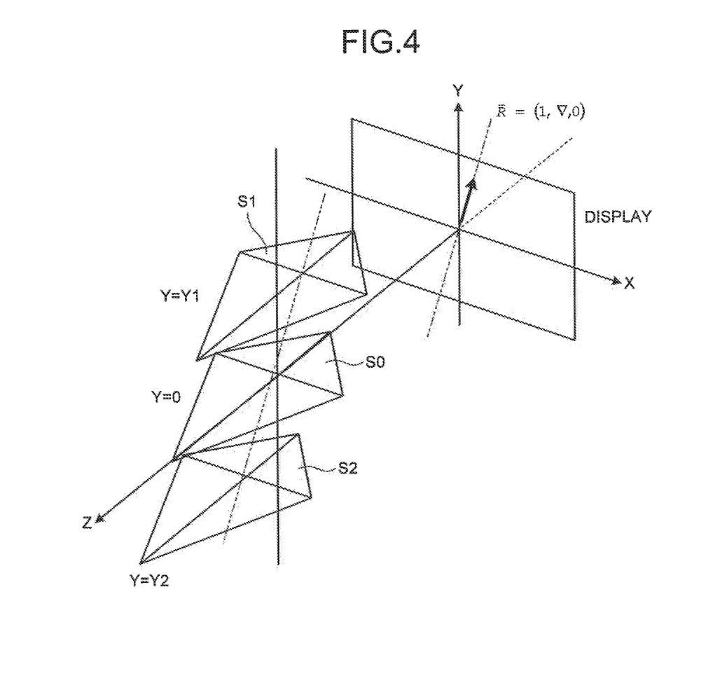

In the case when the optical apertures are disposed at a tilt as is the case in the first embodiment, the positions of the optical apertures and the positions of the display pixels are out of line in the row direction in the example illustrated in FIG. 3, the second direction). As a result, for each different height, the position of the visible area is different. FIG. 4 is a diagram that schematically illustrates a visible area S1 in a plane of Y=Y1, a visible area S0 in a plane of Y=0, and a visible area S2 in a plane of Y=Y2 (as an example, herein, Y1>0>Y2 is satisfied). In the example illustrated in FIG. 4, the distance from the display surface (display) to the visible area S1, the distance from the display surface to the visible area S0, and the distance from the display surface to the visible area S2 are identical.

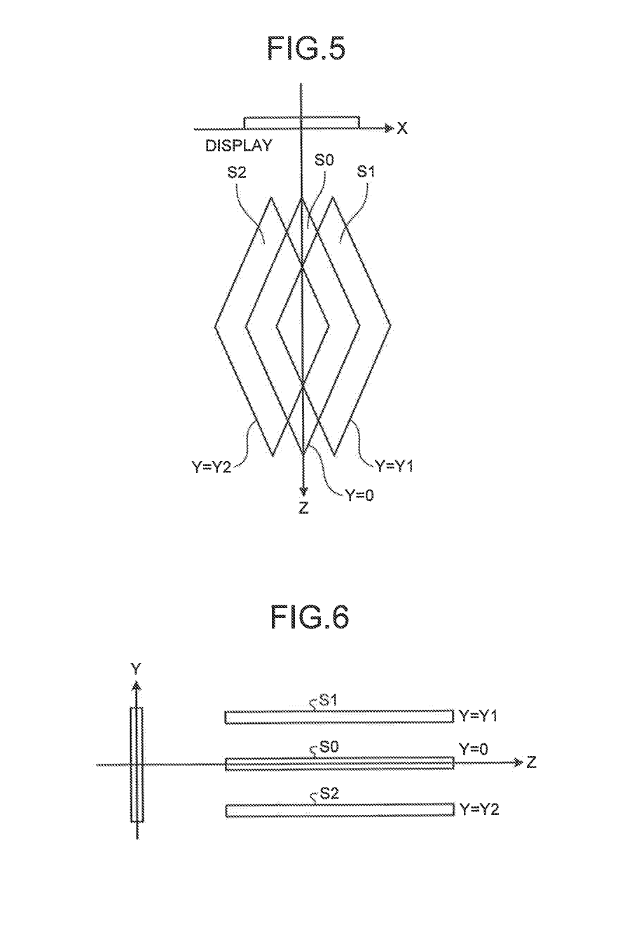

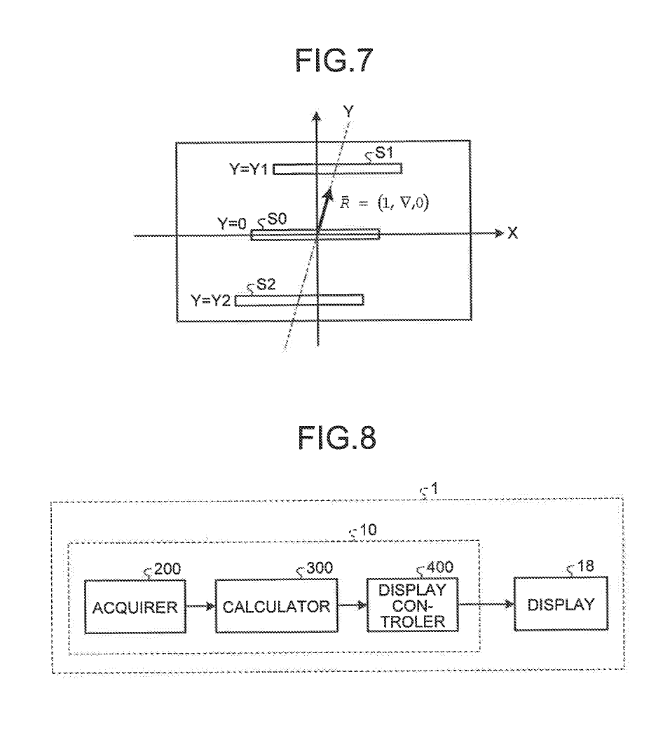

FIG. 5 is a diagram (an X-Z planar view) illustrating a state in which the display surface and the visible areas S1, S0, and S2 are looked down from above. FIG. 6 is a diagram (a Y-Z planar view) illustrating a state in which the display surface and the visible areas S1, S0, and S2 are looked from a side. FIG. 7 is a diagram. (an X-Y planar view) illustrating a state in which the display surface and the visible areas S1, S0, and S2 are looked from the front side. As can be understood from FIG. 5, the visible areas S1, S0, and S2 are mutually out of line in the X-direction. Moreover, as can be understood from FIG. 7, at each different height, the visible areas are out of line along the vector R. Furthermore, the amount by which the visible areas are out of line can be acquired from the difference in heights and the tilt of the vector R. That is, in this example, it can be regarded that the visible areas S1, S0, and S2 extend obliquely in the height direction (the Y-direction).

Meanwhile, in the display 18 according to the first embodiment, the setting is such that the extending direction of the optical apertures has a predetermined tilt with respect to the first direction of the display element 20 (i.e., a slanted lens is used as the aperture controller 26). However, that is not the only possible case. That is, as long as the display 18 is capable of displaying stereoscopic images having a different visible area for each different height, it serves the purpose.

FIG. 3 is a block diagram illustrating a configuration example of the image processing device 10. As illustrated in FIG. 8, the image processing device 10 includes an acquirer 200, a calculator 300, and a display controller 400.

The acquirer 200 acquires a three-dimensional coordinate value that indicates the position of the viewer in the real space within the visible area. As far as the acquirer 200 is concerned, it is possible to use, for example, an imaging device such as a visible camera or an infrared camera or a device such as radar or a sensor. In such a device, by implementing a known technology, the position of the viewer is acquired from the information that is acquired (in the case of a camera, from a captured image). For example, if a visible camera is used, the image acquired by means of imaging is subjected to image analysis so as to detect a viewer and to calculate the position of the viewer. With that, the acquirer acquires the position of the viewer. Alternatively, if radar is used, then the radar signals that are acquired are subjected to signal processing so as to detect a viewer and to calculate the position of the viewer. With that, the acquirer acquires the position of the viewer. Meanwhile, during human detection and position calculation, as far as the detection of a viewer is concerned, it is possible to detect an arbitrary target such as the face, the head, the person in entirety, or a marker that enables determination that the person is present. Moreover, the method of acquiring the position of a viewer is not limited to the method described above.

The calculator 300 calculates, using the three-dimensional coordinate value acquired by the acquirer 200, a reference coordinate value that indicates the position of the viewer in a reference place which is set in advance. As long as the reference plane is included in the visible area, it serves the purpose. In the first embodiment, any one of the planes that are not parallel to the vector R can be treated as the reference plane.

For example, the plane of Y=0 passing through the center of the display can be treated as the reference plane. Alternatively, the plane of Y=C (where C is a constant number corresponding to design conditions) can be treated as the reference plane. Still alternatively, a plane (Y=Yi) having the same height as the height of a particular viewer i can be treated as the reference plane. Still alternatively, a plane passing through the positions of a plurality of viewers can be treated as the reference plane. In this case, if three or fewer viewers are present, then it becomes possible to minimize the error occurring due to projection (described later). Moreover, still alternatively, a plane having the smallest sum of distances from a plurality of viewers can be treated as the reference plane. In this case, even if three or more viewers are present, it becomes possible to minimize the error occurring due to projection (described later). Furthermore, still alternatively, a plane passing through the optical axis of the camera that monitors the viewers can be treated as the reference plane. In this case, the monitoring error decreases to the minimum.

Given below is the explanation of a method of calculating the reference coordinate value. As an example, the calculator 300 according to the first embodiment calculates, as the reference coordinate value, a coordinate value at which the three-dimensional coordinate value acquired by the acquirer 200 is projected onto the reference plane along the vector (along the extending direction of visible areas). Herein, assume that (Xi, Yi, Zi) represents the three-dimensional coordinate value of the viewer as acquired by the acquirer 200, and (a, b, c) represents a normal vector n of the reference plane. Then, using the normal vector n=(a, b, c), the reference plane can be expressed as given below in Equation (2).

aX+bY+cZ+d=0 (2)

If the three-dimensional coordinate value (Xi, Yi, Zi) that is acquired by the acquirer 200 is shifted along the vector R, then the coordinate value at the destination can be expressed using an arbitrary real number t and as given below in Equation (3).

Coordinate value at destination=(Xᵢ+t,Yᵢ+t∇,Zᵢ) (3)

If the coordinate value given in Equation (3) is substituted in Equation (2), then Equation (4) is established.

a(Xᵢ+t)+b(Yᵢ+t∇)+cZᵢ+d=0 (4)

If Equation (4) is solved in terms of t and substituted in Equation (3) , then a reference coordinate value (Xi2, Yi2, Zi2), which indicates the position of the viewer in the reference plane, can be expressed as given below in Equation (5).

$$( {X}_{i 2} , {Y}_{i 2} , {Z}_{i 2} ) = ( {X}_{i} + \frac{- {bY}_{i} - {cZ}_{i} - d}{{aX}_{i} + b ∇} , {Y}_{i} + ∇ \frac{- {bY}_{i} - {cZ}_{i} - d}{{aX}_{i} + b ∇} , {Z}_{i} ) \qquad ( 5 )$$

Particularly, when the plane of Y=0 is treated as the reference plane, the reference coordinate value (Xi2, Yi2, Zi2) indicating the position of the viewer in that reference plane can be expressed using Equation (6). Herein, Equation (6) indicates that the Y component, which represents simply the component of the height direction, is shifted along with the vector R.

$$( {X}_{i 2} , {Y}_{i 2} , {Z}_{i 2} ) = ( {X}_{i} + \frac{- {Y}_{i}}{∇} , 0 , {Z}_{i} ) \qquad ( 6 )$$

In this way, using the three-dimensional coordinate value acquired by the acquirer 200, it is possible to calculate the reference coordinate value that indicates the position of the viewer in the reference plane. As a result, it becomes possible to acquire the positional relationship between the visible area in the reference plane and the reference coordinate value, which indicates the position of the viewer in the reference plane. If the reference coordinate value is included in the visible area in the reference plane, then the viewer becomes able to recognize stereoscopic images from the current position. On the other hand, if the reference coordinate value is not included in the visible area in the reference plane, then it becomes difficult for the viewer to recognize stereoscopic images from the current position.

If the vector R that indicates the extending direction of the visible areas in the height direction is known and if the visible area in a predetermined plane other than the reference plane is known, the it is possible to identify the visible area in the reference plane. More particularly, for example, when the (Xp, Y0, Zp) represents the coordinate value in the visible area in the plane of Y=0; if that coordinate value (Xp, Y0, Zp) is converted into a coordinate value in the reference plane using Equation (5) given above, then the post-conversion coordinate value becomes a coordinate value within the visible area in the reference plane. In this way, it is possible to identify the visible area in the reference plane.

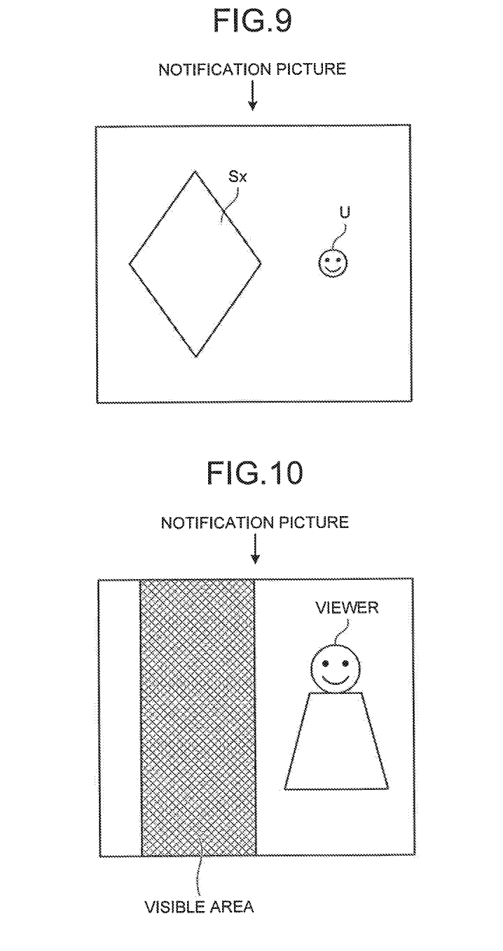

The display controller 400 controls the display 18 to display information corresponding to the reference coordinate value calculated by the calculator 300. In the first embodiment, the display controller 400 controls the display 18 to display a notification to the viewers about the reference coordinate value calculated by the calculator 300 and the positional relationship with the visible area in the reference plane. Looking at the notification, a viewer can easily understand whether or not it is possible to recognize stereoscopic images from his or her current position. Herein, the method of notification can be arbitrary. For example, the reference coordinate value and the positional relationship with the visible area in the reference plane can be displayed without modification. Alternatively, a picture can be displayed to inform the viewer about a position to which the viewer can move to be able to recognize stereoscopic images. For example, as illustrated in FIG. 9, as a notification picture, it is possible to display a picture illustrating the reference plane when looked down from above. In FIG. 9, Sx represents the visible area in the reference plane and U represents the position of a user. When the viewer views the notification picture, he or she becomes able to understand the relative positional relationship between the visible area in the reference plane and himself or herself. In the first embodiment, the position of the viewer is displayed upon correcting it to be present in the reference plane. However, for example, if the plane Y=Yx including the position of a viewer serves as the reference plane, then the visible area in a plane (such as the plane of Y=0) other than the reference plane can be projected onto the reference plane (in this example, the plane of Y=Yx) so as to determine the position of the visible area in the reference plane; and that visible area can be displayed along with the position of the viewer. Alternatively, for example, as illustrated in FIG. 10, a picture capturing the viewer from the front side and a picture indicating the visible area can also be displayed as the notification picture. Herein, the actual visible area extends at a tilt in the height direction. However, in the example illustrated in FIG. 10, pictures are displayed in which the visible area is converted to extend parallel to the height direction. As a result, it becomes possible to enhance the visibility of the picture of the visible area. However, that is not the only possible case. Alternatively, the display controller 400 can control the display 18 to display a picture in which the visible area extends at a tilt in the height direction without being subjected to the abovementioned correction.

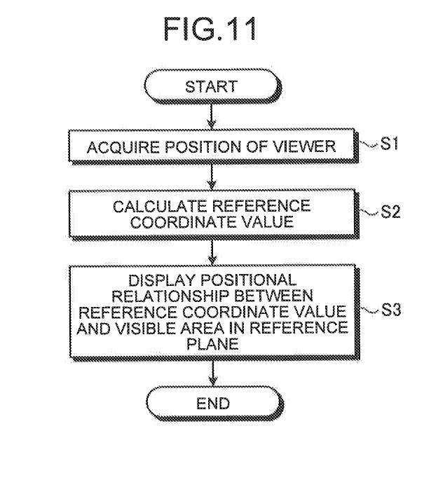

FIG. 11 is a flowchart for explaining an example of the operations performed in the image processing device 10 according to the first embodiment. As illustrated in FIG. 11, firstly, the acquirer 200 acquires a three-dimensional coordinate value that indicates the position of a viewer (Step S1). Then, using the three-dimensional coordinate value acquired at Step S1, the calculator 300 calculates a reference coordinate value that indicates the position of the viewer in a reference plane (Step S2). The display controller 400 controls the display 18 to display a notification about the reference coordinate value, which is calculated at Step S2, and the positional relationship with the visible area in the reference plane (Step S3).

As explained above, in the first embodiment, using the three-dimensional coordinate value including the position of the viewer in the height direction, the reference coordinate value is calculated that indicates the position of the viewer in the reference plane. Then, the viewer is notified about the reference coordinate value that is calculated and about the positional relationship with the visible area in the reference plane. With that, the viewer can easily understand whether or not it is possible to recognize stereoscopic images from his or her current position. For example, consider that a viewer is present at a height that is different than the height of the supposed viewing position. Then, by looking at the notification picture displayed on the display 18, the viewer can immediately understand that it is not possible to recognize stereoscopic images from his or her current position.

### Second Embodiment

An image processing device 100 according to a second embodiment differs from the first embodiment in the way that the position of the visible area in the reference plane is determined in such a way that the reference coordinate value calculated by the calculator 300 is included in the visible area, and the display 18 is controlled in such a way that the visible area is formed at the determined position. The concrete explanation is given below. Meanwhile, the constituent elements identical to the first embodiment are referred to by the same reference numerals, and the explanation thereof is not repeated.

Prior to the explanation of the image processing device 100 according to the second embodiment, the explanation is given about a method of controlling the setting position or the setting range of the visible area. For the purpose of illustration, the following explanation is given for an example of the visible area in the plane of Y=0. The position of the visible area is determined according to a combination of display parameters of the display 18. Examples of the display parameters include a shift in display images, the distance (clearance gap) between the display element 20 and the aperture controller 26, the pitch of pixels, and the rotation, deformation, and movement of the display 18.

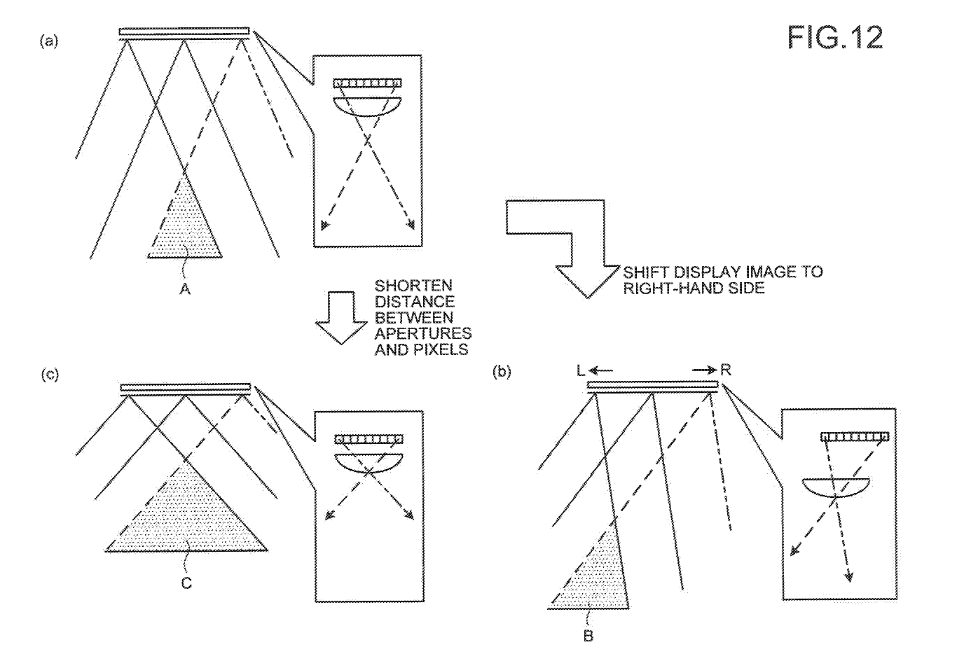

FIG. 12 to FIG. 14 are diagrams for explaining the control performed with respect to the setting position and the setting range of the visible area. Firstly, explained with reference to FIG. 12 is a case in which the position of setting the visible area is controlled by adjusting the shift in the display image or by adjusting the distance (clearance gap) between the display element 20 and the aperture controller 26. With reference to FIG. 12, for example, if the display image is shifted in the right-hand direction (in section (b) of FIG. 12, see the direction of an arrow R), then the light beams tilt toward the left-hand direction (in section (b) of FIG. 12, the direction of an arrow L) and the visible area shifts in the left-hand direction (in section (b) of FIG. 12, see a visible area B). Conversely, if the display image is shifted to the left-hand direction as compared to section (a) of FIG. 12, then the visible area shifts in the right-hand direction (not illustrated).

As illustrated in section (a) of FIG. 12 and section (c) of FIG. 12, shorter the distance between the display element 20 and the aperture controller 26, closer becomes the position from the display 18 at which the visible area can be set. Moreover, closer the position from the display 18 at which the visible area is set, greater is the decrease in the light beam density. Meanwhile, longer the distance between the display element 20 and the aperture controller 26, farther becomes the position from the display 18 at which the visible area can be set.

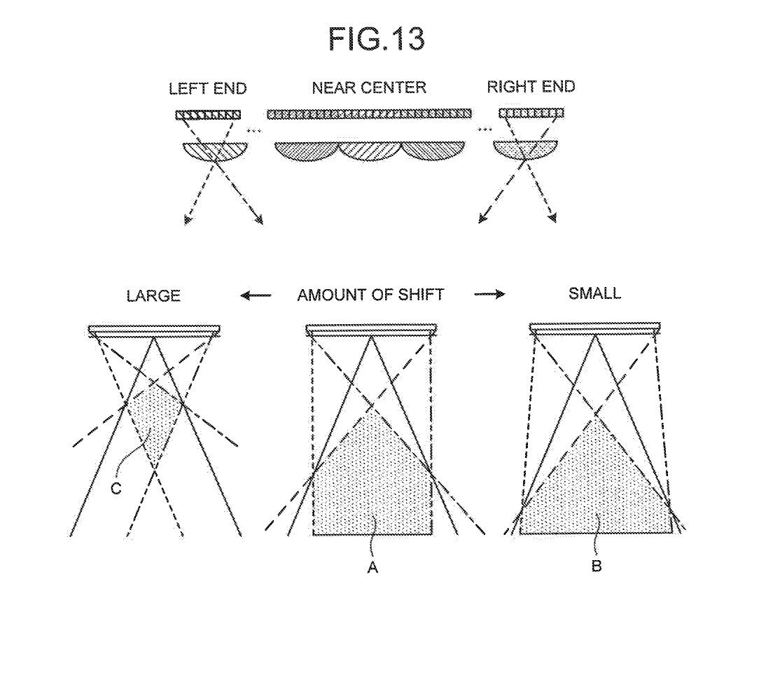

Explained below with reference to FIG. 13 is a case in which the position for setting the visible area is controlled by adjusting the arrangement (pitch) of the pixels displayed in the display element 20. Herein, the visible area can be controlled by making use of the fact that the positions of the pixels and the aperture controller 26 shift out of line in a relatively large way more toward the ends (the right, end (in FIG. 13, the end in the direction of the arrow R) and the left end (in FIG. 13, the end in the direction of the arrow L) of the screen of the display element 20. If the amount by which the positions of the pixels and the aperture controller 26 relatively shift out of line is increased, then the visible area changes from a visible area A to a visible area C illustrated in FIG. 13. Conversely, if the amount by which the positions of the pixels and the aperture controller 26 relatively shift out of line is decreased, then the visible area changes from the visible area A to a visible area B illustrated in FIG. 13. Meanwhile, the maximum length of the width of a visible area (the maximum length in the horizontal direction of a visible area) is called a visible area setting distance.

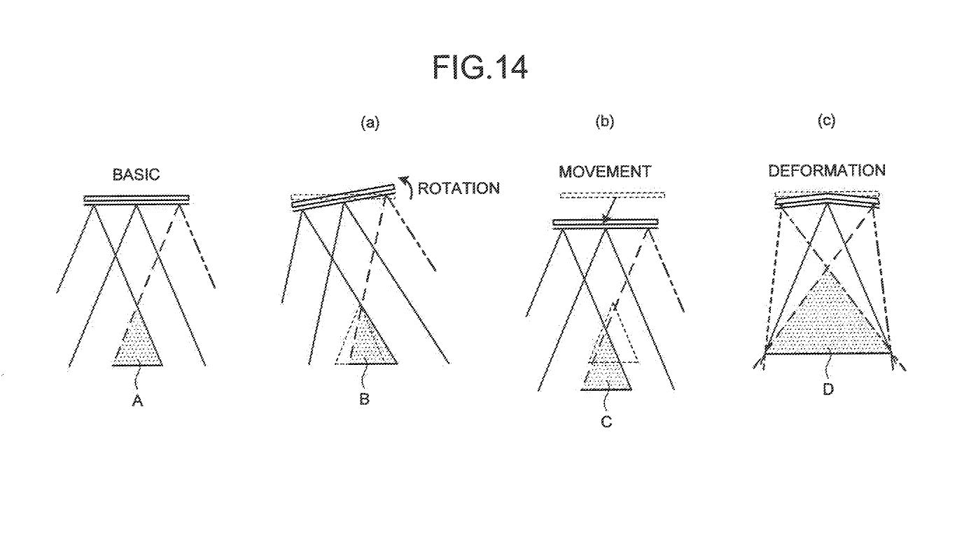

Explained below with reference to FIG. 14 is a case in which the position for setting the visible area is controlled by means of the rotation, deformation, and movement of the display 18. As illustrated in section (a) of FIG. 14, if the display 18 is rotated, then the visible area A in the basic state can be changed to the visible area B. As illustrated in section (b) of FIG. 14, if the display 18 is rotated, then the visible area A in the basic state can be changed to the visible area C. As illustrated in section (c) of FIG. 14, if the display 18 is subjected to deformation, then the visible area A in the basic state can be changed to a visible area D. In this way, the position of the visible area in the plane of Y=0 is determined according to a combination of display parameters of the display 18.

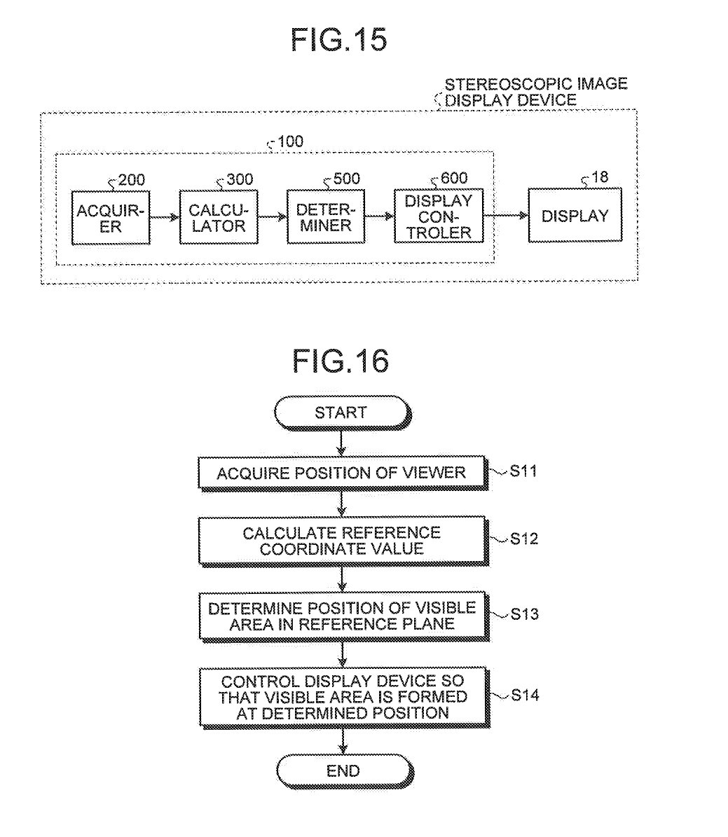

FIG. 15 is a block diagram illustrating an example of the image processing device 100 according to the second embodiment. As illustrated in FIG. 15, the image processing device 100 further includes a determiner 500.

The determiner 500 determines the visible area in the reference plane in such a way that the reference coordinate value calculated by the calculator 300 is included in the visible area. For example, in a memory (not illustrated), it is possible to store in advance various types of visible areas that can be set in the reference plane as well as to store in advance the data corresponding to the combination of display parameters used for determining the positions of those visible areas. Then, the determiner 500 can search the memory for the visible area that includes the reference coordinate value calculated by the calculator 300, and can determine the position of the visible area including the reference coordinate value.

However, that is not the only possible case. That is, the determiner 500 can perform the determination by implementing an arbitrary method. For example, the determiner 500 can perform computations to determine the position of the visible area including the reference coordinate value in the reference plane. In that case, for example, in a memory (not illustrated), the reference coordinate value can be stored in advance in a corresponding manner to an arithmetic expression meant for acquiring the combination of display parameters used in determining the position of the visible area that includes the reference coordinate value in the reference plane. Then, the determiner 500 reads, from the memory, the arithmetic expression corresponding to the reference coordinate value calculated by the calculator 300; acquires the combination of display parameters according to that arithmetic expression; and determines the position of the visible area that includes the reference coordinate value in the reference plane. Meanwhile, if a plurality of viewers is present, then it is desirable to determine the position of the visible area in the reference plane in such a way that as many viewers as possible are included in the visible area.

A display controller 600 according to the second embodiment controls the display 18 in such a way that the visible area is formed at the position determined by the determiner 500. More particularly, the display controller 600 controls, in a variable manner, the combination of display parameters of the display 18 so that the visible area is formed at the position determined by the determiner 500.

FIG. 16 is a flowchart illustrating an example of the operations performed in the image processing device 100 according to the second embodiment. As illustrated in FIG. 16, firstly, the acquirer 200 acquires a three-dimensional coordinate value that indicates the position of the viewer (Step S11). Then, using the three-dimensional coordinate value acquired at Step S11, the calculator 300 calculates a reference coordinate value that indicates the position of the viewer in the reference plane (Step S12). Subsequently, the determiner 500 determines the position of the visible area in the reference plane in such a way that the reference coordinate value calculated at Step S12 is included in the visible area (Step S13). Then, the display controller 600 controls the display 18 in such a way that the visible area is formed at the position determined at Step S13 (Step S14).

As described above, according to the second embodiment, in the reference plane, the visible area is formed in such a way that the reference coordinate value indicating the position of the viewer is included in the visible area. Thus, for example, even in the case when the viewer is present at a different height than the supposed viewing position, the visible area in the reference plane is automatically changed to include the reference coordinate value indicating the position of the viewer. That enables the viewer to view the stereoscopic images without having to change his or her current viewing position.

### Modification of Second Embodiment

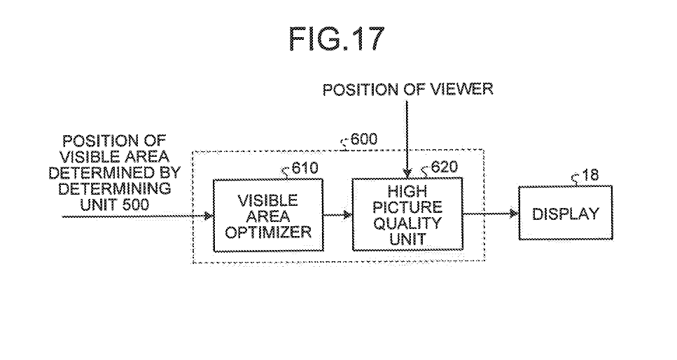

The display controller 600 can also perform an operation to enhance the image quality of the stereoscopic images that are to be viewed from the position indicated by the three-dimensional coordinate value acquired by the acquirer 200. FIG. 17 is a diagram illustrating a configuration example of the display controller 600. As illustrated in FIG. 17, the display controller 600 includes a visible area optimizing unit 610 and a high picture quality unit 620. The visible area optimizing unit 610 controls, in a variable manner, the combination of display parameters of the display 18 in such a way that the visible area is formed at the position determined by the determiner 500, and sends to the high picture quality unit 620 the data of the image to be displayed on the display 18.

The high picture quality unit 620 receives input of image data from the visible area optimizing unit 610 and information indicating the position of the viewer. Herein, the information indicating the position of the viewer can point to the three-dimensional coordinate value acquired by the acquirer 200 or can point to the reference coordinate value calculated by the calculator 300. Then, the high picture quality unit 620 performs processing to enhance the image quality of the stereoscopic images that are to be viewed from the position of the viewer that is input, and controls the display 18 to display the processed image data.

As an example, the high picture quality unit 620 can also perform a filtering operation. More particularly, the high picture quality unit 620 can perform an operation (called a “filtering operation”) in which, when the display 18 is viewed from the position of the viewer that is input, in order to ensure that the light beams coming out from only those pixels which display parallax images (a stereoscopic image) to be viewed reach (and the light beams coming out from the other pixels do not reach) the position of the viewer, a filter (coefficient) meant for the purpose of converting the parallax images is used and the pixel value of each pixel that displays the parallax images is corrected. As a result, it becomes possible to prevent the occurrence of a crosstalk phenomenon in which the light beams coming out from the pixels displaying the parallax images to be viewed gets mixed with some of the light beams coming out from the pixels displaying other parallax images. Hence, it becomes possible to enhance the image quality of the stereoscopic images which are to be viewed.

Meanwhile, the image processing device according to the embodiments and the modification example described above has the hardware configuration that includes a CPU (Central Processing Unit), a ROM, a RAM, and a communication I/F device. Herein, the functions of each of the abovementioned constituent elements are implemented when the CPU loads programs, which are stored in the ROM, in the RAM and executes those programs. However, that is not the only possible case. Alternatively, at least some of the functions of the constituent elements can be implemented using individual circuits (hardware). For example, at least the acquirer 200, the calculator 300, and/or the display controller 400/600 may be configured from a semiconductor integrated circuit.

Meanwhile, the programs executed in the image processing device according to the embodiments and the modification example described above can be saved as downloadable files on a computer connected. to the Internet or can be made available for distribution through a network such as the Internet. Alternatively, the programs executed in the image processing device according to the embodiments and the modification example described above can be stored in advance in a ROM or the like.

Alternatively, some or all of the functions of the abovementioned constituent elements can be realized by both software and hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising:
an acquirer configured to acquire a three-dimensional coordinate value that indicates a position of a viewer;
a calculator configured to, using the three-dimensional coordinate value, calculate a reference coordinate value that indicates a position of the viewer in a reference plane that includes a visible area within which the viewer is able to view a stereoscopic image; and
a display controller configured to control a display, which displays the stereoscopic image for which the visible area is different for each different height, so as to display information corresponding to the reference coordinate value.

2. The device according to claim 1, wherein the display controller controls the display to display a notification to the viewer about the reference coordinate value and a positional relationship with the visible area in the reference plane.

3. The device according to claim 2, wherein
the visible area extends at a tilt in the height direction, and
the calculator calculates, as the reference coordinate value, a coordinate value at which the three-dimensional coordinate value is projected onto the reference plane along the extending direction of the visible area.

4. The device according to claim 3, wherein the reference plane is a plane not parallel to the extending direction of the visible area.

5. The device according to claim 1, further comprising a determiner configured to determine a position of the visible area in the reference plane in such a way that the reference coordinate value calculated by the calculator is included in the visible area, wherein
the display controller controls the display in such a way that the visible area is formed at the position determined by the determiner.

6. The device according to claim 5, wherein the display controller performs an operation to enhance image quality of the stereoscopic image which is to be viewed at a position indicated by the three-dimensional coordinate value.

7. The device according to claim 1, wherein the acquirer, the calculator, and the display controller are implemented as a processor.

8. A stereoscopic image display comprising:
a display configured to display a stereoscopic image having a different visible area, within which a viewer is able to view the stereoscopic image, for each different height;
an acquirer configured to acquire a three-dimensional coordinate value that indicates a position of the viewer;
a calculator configured to, using the three-dimensional coordinate value, calculate a reference coordinate value that indicates a position of the viewer in a reference plane that includes the visible area; and
a display controller configured to control the display so as to display information corresponding to the reference coordinate value.

9. The stereoscopic image display according to claim 8, wherein the display controller controls the display to display a notification to the viewer about the reference coordinate value and a positional relationship with the visible area in the reference plane.

10. The stereoscopic image display according to claim wherein
the visible area extends at a tilt in the height direction, and
the calculator calculates, as the reference coordinate value, a coordinate value at which the three-dimensional coordinate value is projected onto the reference plane along the extending direction of the visible area.

11. The stereoscopic image display according to claim 10, wherein the reference plane is a plane not parallel to the extending direction of the visible area.

12. The stereoscopic image display according to claim 8, further comprising a determiner configured to determine a position of the visible area in the reference plane in such a way that the reference coordinate value calculated by the calculator is included in the visible area, wherein
the display controller controls the display in such a way that the visible area is formed at the position determined by the determiner.

13. The stereoscopic image display according to claim 12, wherein the display controller performs an operation to enhance image quality of the stereoscopic image which is to be viewed at a position indicated by the three-dimensional coordinate value.

14. The stereoscopic image display according to claim 8, wherein the acquirer, the calculator, and the display controller are implemented as a processor.

15. An image processing method comprising:
acquiring a three-dimensional coordinate value that indicates a position of a viewer;
calculating, using the three-dimensional coordinate value, a reference coordinate value that indicates a position of the viewer in a reference plane that includes a visible area within which the viewer is able to view a stereoscopic image; and
controlling a display, which displays the stereoscopic image for which the visible area is different for each different height, so as to display information corresponding to the reference coordinate value.
